(19) United States
(12) Patent Application Publication
(10) Pub. No.: US 2025/0182628 A1
(43) Pub. Date: Jun. 5, 2025

(54) METHOD FOR AN AIRCRAFT TO MANAGE THE BATTERY IN ACCORDANCE WITH THE FLIGHT PLAN THAT INCLUDES TAKE-OFF AND LANDING

(71) Applicant: VSPACE CO., LTD., Gumi-si (KR)

(72) Inventors: Bumdong CHO, Gumi-si (KR); Yunji SIM, Gumi-si (KR); Suho YU, Gumi-si (KR)

(73) Assignee: VSPACE CO., LTD., Gumi-si (KR)

(21) Appl. No.: 18/813,988

(22) Filed: Aug. 23, 2024

(30) Foreign Application Priority Data
Dec. 1, 2023 (KR) 10-2023-0172187
Jan. 11, 2024 (KR) 10-2024-0004710

(51) Int. Cl. G08G 5/00; B60L 58/13

(52) U.S. Cl. CPC G08G 5/34; B60L 58/13; G08G 5/21; G08G 5/55; G08G 5/59; G08G 5/76; B60L 2200/10; B60L 2240/66

(57) ABSTRACT

Provided is the method for managing a battery according to a flight plan using operation status information including takeoff and landing of an aircraft. The method includes a step of calculating a battery consumption amount consumed during movement to a destination according to the flight plan and obtaining a flight plan based on the battery consumption amount and the current remaining battery amount of the aircraft; a step of generating a modified flight plan by modifying the flight plan based on aircraft movement information including vertical movement and horizontal movement rates of the aircraft; and a step of determining the modified flight plan as a final flight plan.

### CROSS-REFERENCE TO RELATED APPLICATIONS

This application claims priority to Korean Patent Application No. 10-2023-0172187 filed on Dec. 1, 2023 and Korean Patent Application No. 10-2024-0004710 filed on Jan. 11, 2024, the entire contents of which are herein incorporated by reference.

### TECHNICAL FIELD

The present disclosure relates to a method for managing batteries in accordance with a flight plan that includes takeoff and landing for an aircraft. Specifically, the present disclosure relates to a method for managing batteries that check the amount of battery that can be moved to a destination during flight of an aircraft, and specifically check the amount of battery consumption through the movement division (vertical and horizontal movement) of the aircraft, thereby preventing accidents that may occur due to insufficient battery and supporting effective operation.

### TECHNOLOGY UNDERLYING THE INVENTION

Cities around the world are becoming increasingly large due to the phenomenon of urban concentration, in which large numbers of people are flocking to large cities.

This urban concentration has caused many problems in various aspects such as traffic, environment, and energy, and the cars filling the city roads have caused severe traffic congestion and environmental pollution, resulting in enormous economic and social losses. Accordingly, many countries are making efforts to reduce fossil fuel consumption and transition to eco-friendly energy by using various methods such as imposing large taxes on fossil fuel-using machines such as diesel and gasoline engines and providing subsidies to eco-friendly vehicles such as electric vehicles.

In addition, it is known that the country is suffering a lot of losses due to severe urban traffic problems, and that Korea is also suffering traffic congestion loss costs amounting to trillions of won.

Accordingly, UAM (Urban Air Mobility) based on eVTOL (electric Vertical Take-off and Landing), a short-distance urban air mobility, is emerging as a major technological challenge.

UAM is an air mobility that takes off vertically from an urban area, moves to a destination, and then lands vertically at the destination.

If UAM were to be powered by batteries without using conventional fossil fuels, it would have to be equipped with a large amount of batteries to take off, land, and operate for a long time, and as the battery capacity increases, the weight of UAM increases, so more batteries must be installed to compensate for this, which creates a contradiction. UAM, an electric aircraft with vertical takeoff and landing features that can accommodate multiple passengers, can be operated efficiently only if there is a way to increase energy density while reducing the weight of the battery.

For aircraft that utilize electric energy such as UAM, a battery management system may be very important. The battery management system is configured with a device that calculates and informs the remaining usage through the state of charge (SOC: State of Charge) of the secondary battery, and the remaining amount can be used to determine the remaining battery capacity, but there was a problem that it was not possible to know whether the destination can be reached using the battery.

Accordingly, research is ongoing on a battery management method that can determine the remaining battery capacity in real time and move to the destination according to the flight plan.

### SUMMARY

### Problem to be Solved

The purpose of the present invention is to propose a battery management system suitable for batteries in consideration of the operation of UAM, and to provide a battery management method that can maximize the safety and power efficiency of UAM by regenerating the flight plan by determining whether the destination can be reached by obtaining a flight plan and confirming it with the passenger.

### Means for Solving the Problem

One embodiment of the present disclosure for solving the above-described problem may include the following steps in a method for managing a battery according to a flight plan using operational status information including takeoff and landing of an aircraft.

A step of calculating a battery consumption amount consumed during movement to a destination according to the flight plan and obtaining a flight plan based on the battery consumption amount and the current remaining battery amount of the aircraft; A step of generating a modified flight plan by modifying the flight plan based on aircraft movement information including vertical movement and horizontal movement rates of the aircraft; and A step of determining the modified flight plan as a final flight plan.

The step of generating the modified flight plan may apply a predetermined ratio to the battery consumption amount according to weather conditions.

The step of generating the modified flight plan may calculate the amount of battery required to move to the destination by reflecting the vertical movement/horizontal movement rate at the maximum value during flight from the current location to the destination when the vertical movement/horizontal movement rate for the movement section up to the present during the flight of the aircraft is higher than the predetermined ratio compared to the vertical movement/horizontal movement rate according to the flight plan. The step of generating the above modified flight plan may obtain base information including information on charging locations and landing locations included in an area movable by the battery capacity of the aircraft, and determine a location among the base information that is close to the destination by a preset value as a temporary candidate destination.

The step of generating the above modified flight plan may transmit inquiry data for confirming whether landing is possible for the above temporary candidate destination, and determine the candidate destination based on response data to the inquiry data transmitted from the above temporary candidate destination.

The step of determining the above modified flight plan may provide the above candidate destination information to the passenger, determine a location according to destination selection information selected by the passenger among the provided candidate destination information as a landing destination, and determine the landing destination as the destination of the above modified flight plan.

In the step of generating the above modified flight plan, when the priority transit location selected by the passenger among the charging location and the landing location is a charging location, when determining the above temporary candidate destination, the charging location is first selected, but if the charging location is less than the preset value, the landing location may be additionally selected. In the step of generating the modified flight plan, when the priority stopover location selected by the passenger among the charging location and the landing location is the landing location, when determining the temporary candidate destination, the landing location is selected first, and the landing location is less than or equal to a preset value. In this case, you can additionally select the above charging location.

### Effect of the Invention

According to one embodiment of the present disclosure, there is an effect of obtaining a flight plan that enables movement to a destination according to the state of the battery according to UAM operation.

### BRIEF DESCRIPTION OF THE DRAWINGS

FIG. 1 is a drawing for explaining a computing device according to one embodiment of the present disclosure.

FIG. 2 is a general schematic diagram of an exemplary computing environment in which embodiments of the present disclosure can be implemented.

FIG. 3 is a drawing schematically illustrating a UAM utilization scheme according to one embodiment of the present disclosure.

FIG. 4 is a drawing schematically illustrating each step according to one embodiment of the present disclosure.

FIG. 5 is a drawing schematically illustrating the internal configuration of a UAM according to one embodiment of the present disclosure.

FIG. 6 is a drawing schematically illustrating each step according to another embodiment of the present disclosure.

### DETAILED DESCRIPTION

Various embodiments are now described with reference to the drawings. In this specification, various descriptions are provided to provide an understanding of the present disclosure. However, it will be apparent that these embodiments may be practiced without these specific descriptions.

The terms “component,” “module,” “system,” and the like, as used herein, refer to computer-related entities, hardware, firmware, software, combinations of software and hardware, or execution of software. For example, a component may be, but is not limited to, a procedure running on a processor, a processor, an object, a thread of execution, a program, and/or a computer. For example, an application running on a computing device and the computing device may both be components. One or more components may reside within a processor and/or thread of execution. A component may be localized within a single computer. A component may be distributed between two or more computers. Additionally, these components may be executed from various computer-readable media having various data structures stored therein. Components may communicate via local and/or remote processes, for example, via signals having one or more data packets (e.g., data from one component interacting with another component in a local system, a distributed system, and/or data transmitted via signals to another system and/or over a network such as the Internet).

In addition, the term “or” is intended to mean an inclusive “or” rather than an exclusive “or.” That is, unless otherwise specified or clear from context, “X utilizes A or B” is intended to mean one of the natural inclusive permutations. That is, if X utilizes A; X utilizes B; or X utilizes both A and B, “X utilizes A or B” can apply to any of these cases. Furthermore, the term “and/or” as used herein should be understood to refer to and encompass all possible combinations of one or more of the relevant items listed.

In addition, the terms “comprises” and/or “comprising” should be understood to mean that the relevant features and/or components are present. However, it should be understood that the terms “comprises” and/or “comprising” do not exclude the presence or addition of one or more other features, components, and/or groups thereof. Furthermore, unless otherwise specified or clear from the context to refer to the singular form, the singular should generally be construed as meaning “one or more.”

And, the term “at least one of A or B” should be construed to mean “only including A,” “only including B,” or “in combination with a configuration of A and B.”

Those skilled in the art should additionally recognize that the various exemplary logical blocks, configurations, modules, circuits, means, logics, and algorithm steps described in connection with the embodiments disclosed herein may be implemented as electronic hardware, computer software, or combinations of both. To clearly illustrate the interchangeability of hardware and software, the various exemplary components, blocks, configurations, means, logics, modules, circuits, and steps have been described above generally in terms of their functionality. Whether such functionality is implemented as hardware or software depends on the particular application and design constraints imposed on the overall system. Skilled artisans may implement the described functionality in a variety of ways for each particular application. However, such implementation decisions should not be construed as causing a departure from the scope of the present disclosure.

The description of the disclosed embodiments is provided to enable a person skilled in the art to make or use the present disclosure. Various modifications to these embodiments will be apparent to a person skilled in the art. The general principles defined herein may be applied to other embodiments without departing from the scope of the present disclosure. Thus, the present disclosure is not limited to the embodiments set forth herein. The present disclosure is to be construed in the broadest sense consistent with the principles and novel features set forth herein.

The method of managing a battery in response to takeoff and landing of an aircraft according to the present disclosure may be applied to electric drive units of various mobility such as automobiles, UAMs, ships, and airplanes that use batteries. In addition, the aircraft may include an airplane equipped with a computing device, an Advanced Air Mobility (AAM), and an electric propulsion aircraft.

Specifically, the Advanced Air Mobility (AAM) may include an Urban Air Mobility (UAM), a Regional Air Mobility (RAM), a drone, and an Unmanned Aerial Vehicle (UAV), and the electric propulsion aircraft may include an Electric Vertical Take-Off and Landing (eVTOL), an Electric Short Take-Off and Landing (eSTOL), and an Electric Conventional Take-Off and Landing (eCTOL).

In particular, it may be desirable to apply it to Urban Air Mobility (UAM). UAM (Urban Air Mobility) uses a battery for flight, but in most cases, it is operated remotely or autonomously without a pilot on board the aircraft, and accordingly, it may not be easy to respond to various battery problems. Hereinafter, a method of managing a battery by utilizing the takeoff and landing of an aircraft, in which a computing device built into the aircraft monitors various sensors to connect or disconnect the power source and the power unit in order to manage such UAM (Urban Air Mobility) batteries, will be described with reference to drawings.

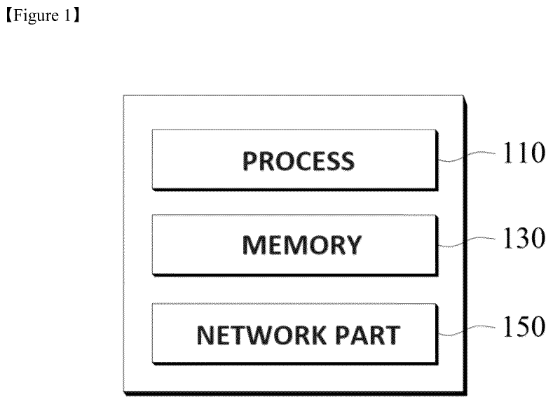

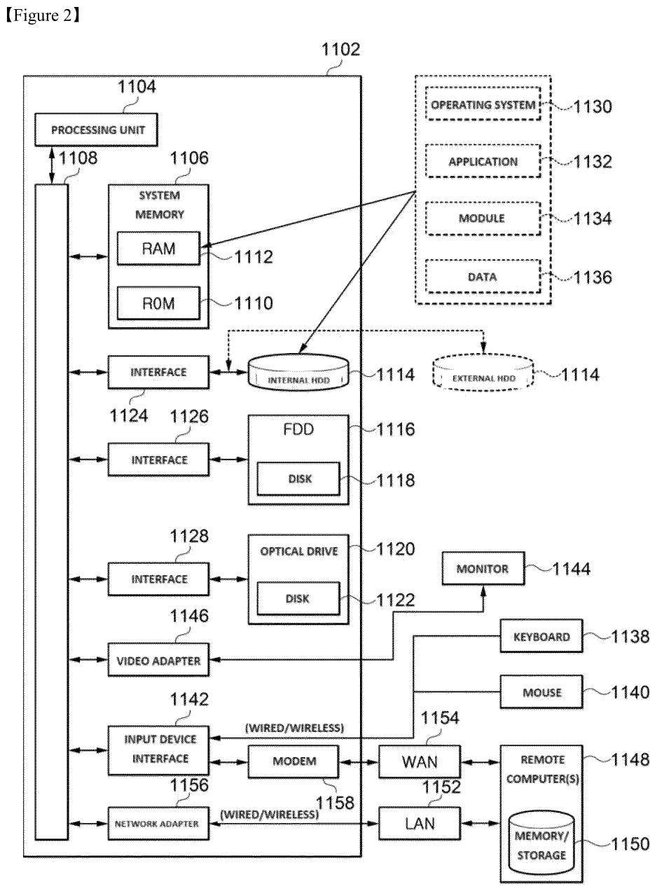

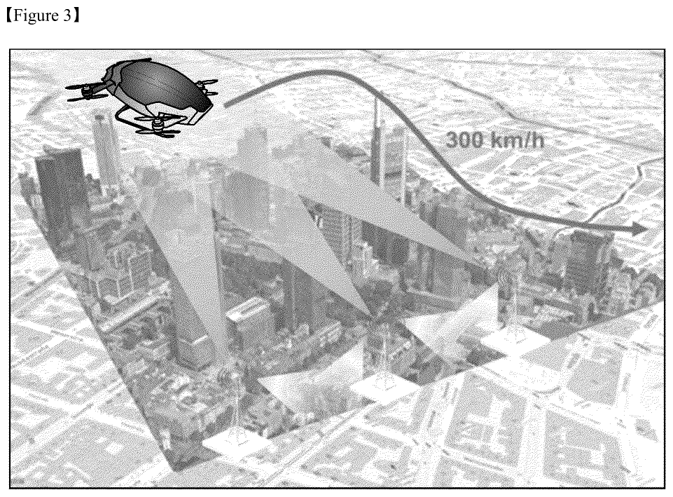

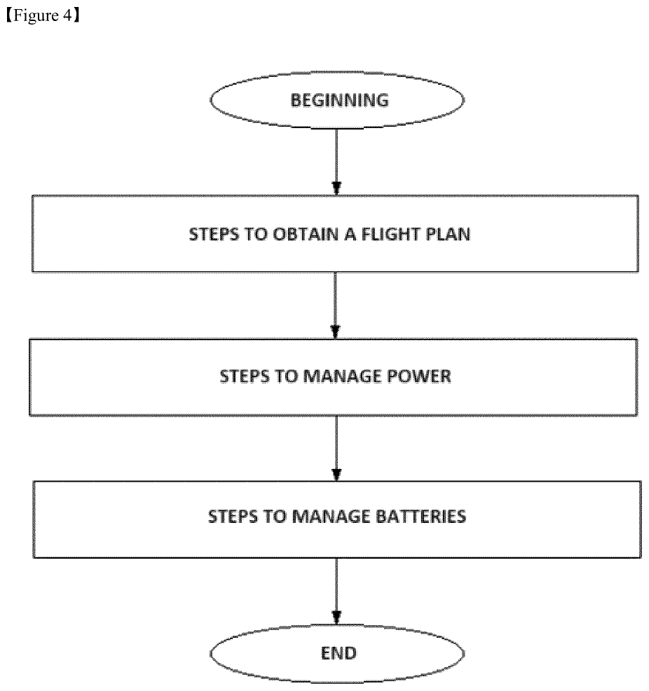

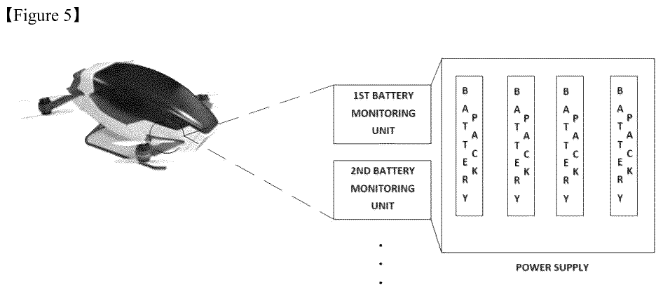

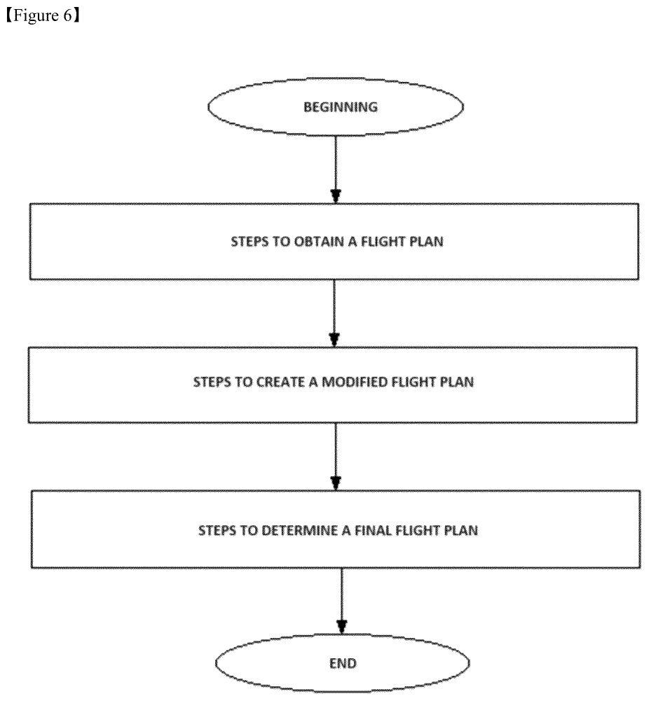

FIG. 1 is a drawing for explaining a computing device according to an embodiment of the present disclosure, FIG. 2 is a general schematic diagram of an exemplary computing environment in which embodiments of the present disclosure can be implemented, FIG. 3 is a drawing schematically illustrating a UAM utilization scheme according to an embodiment of the present disclosure, FIG. 4 is a drawing schematically illustrating each step according to an embodiment of the present disclosure, FIG. 5 is a drawing schematically illustrating the internal configuration of a UAM according to an embodiment of the present disclosure, and FIG. 6 is a drawing schematically illustrating each step according to another embodiment of the present disclosure.

The configuration of the computing device (100) illustrated in FIG. 1 is merely an example that is simplified. In one embodiment of the present disclosure, the computing device (100) may include other components for performing a computing environment of the computing device (100), and only some of the disclosed components may constitute the computing device (100).

The computing device (100) may include a processor (110), a memory (130), and a network unit (150).

The processor (110) may be composed of one or more cores, and may include a processor for data analysis and deep learning, such as a central processing unit (CPU), a general-purpose graphics processing unit (GPGPU), and a tensor processing unit (TPU) of the computing device. The processor (110) may read a computer program stored in the memory (130) and perform data processing for machine learning according to one embodiment of the present disclosure. According to one embodiment of the present disclosure, the processor (110) may perform operations for learning a neural network. The processor (110) can perform calculations for learning a neural network, such as processing input data for learning in deep learning (DL), extracting features from input data, calculating errors, and updating weights of a neural network using backpropagation. At least one of the CPU, GPGPU, and TPU of the processor (110) can process learning of a network function. For example, the CPU and GPGPU can process learning of a network function and data classification using a network function together. In addition, in one embodiment of the present disclosure, processors of multiple computing devices can be used together to process learning of a network function and data classification using a network function. In addition, a computer program executed in a computing device according to one embodiment of the present disclosure can be a CPU, GPGPU, or TPU executable program. According to one embodiment of the present disclosure, the memory (130) can store information of any form generated or determined by the processor (110) and information of any form received by the network unit (150).

According to one embodiment of the present disclosure, the memory (130) may include at least one type of storage medium among a flash memory type, a hard disk type, a multimedia card micro type, a card type memory (for example, an SD or XD memory, etc.), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, and an optical disk. The computing device (100) may also operate in relation to web storage that performs the storage function of the memory (130) on the internet. The description of the above-described memory is only an example, and the present disclosure is not limited thereto. The network unit (150) according to one embodiment of the present disclosure may use various wired communication systems such as a public switched telephone network (PSTN), xDSL (x Digital Subscriber Line), RADSL (Rate Adaptive DSL), MDSL (Multi Rate DSL), VDSL (Very High-Speed DSL), UADSL (Universal Asymmetric DSL), HDSL (High Bit Rate DSL), and a local area network (LAN).

In addition, the network unit (150) presented in this specification may use various wireless communication systems such as CDMA (Code Division Multi Access), TDMA (Time Division Multi Access), FDMA (Frequency Division Multi Access), OFDMA (Orthogonal Frequency Division Multi Access), SC-FDMA (Single Carrier-FDMA), and other systems.

In the present disclosure, the network unit (150) may be configured regardless of the communication mode, such as wired or wireless, and may be configured with various communication networks, such as a short-range communication network (PAN: Personal Area Network) and a short-range communication network (WAN: Wide Area Network). In addition, the network may be the well-known World Wide Web (WWW), and may also utilize a wireless transmission technology used for short-range communication, such as Infrared Data Association (IrDA) or Bluetooth.

FIG. 2 is a general schematic diagram of an exemplary computing environment in which one embodiment of the present disclosure may be implemented.

Although the present disclosure has been described above as being generally implemented by a computing device, those skilled in the art will appreciate that the present disclosure may be implemented in combination with computer-executable instructions and/or other program modules that may be executed on one or more computers and/or as a combination of hardware and software.

In general, program modules include routines, programs, components, data structures, etc. that perform specific tasks or implement specific abstract data types. Furthermore, those skilled in the art will appreciate that the methods of the present disclosure can be implemented with other computer system configurations, including single-processor or multiprocessor computer systems, minicomputers, mainframe computers, as well as personal computers, handheld computing devices, microprocessor-based or programmable consumer electronics, and the like, each of which can be operatively connected to one or more associated devices.

The described embodiments of the present disclosure can also be implemented in distributed computing environments where certain tasks are performed by remote processing devices that are linked through a communications network. In a distributed computing environment, program modules can be located in both local and remote memory storage devices.

A computer typically includes a variety of computer-readable media. Any media that can be accessed by a computer can be a computer-readable medium, and such computer-readable media can include both volatile and nonvolatile media, transitory and non-transitory media, removable and non-removable media. By way of example and not limitation, computer-readable media may include computer-readable storage media and computer-readable transmission media. Computer-readable storage media include volatile and nonvolatile media, transitory and non-transitory media, removable and non-removable media implemented in any method or technology for storing information such as computer-readable instructions, data structures, program modules, or other data. Computer-readable storage media includes, but is not limited to, RAM, ROM, EEPROM, flash memory or other memory technology, CD-ROMs, digital video disks (DVDs) or other optical disk storage, magnetic cassettes, magnetic tape, magnetic disk storage, or other magnetic storage devices, or any other medium that can be accessed by a computer and used to store the desired information. Computer-readable transmission media typically embodies computer-readable instructions, data structures, program modules, or other data in a modulated data signal, such as a carrier wave or other transport mechanism, and includes all information delivery media. The term modulated data signal means a signal that has one or more of its characteristics set or changed so as to encode information in the signal. By way of example, and not limitation, computer-readable transmission media includes wired media, such as a wired network or direct-wired connection, and wireless media, such as acoustic, RF, infrared, and other wireless media. Combinations of any of the above media are also included within the scope of computer-readable transmission media. An exemplary environment (1100) for implementing various aspects of the present disclosure is illustrated, including a computer (1102), wherein the computer (1102) includes a processing unit (1104), a system memory (1106), and a system bus (1108). The system bus (1108) couples system components, including but not limited to the system memory (1106), to the processing unit (1104). The processing unit (1104) may be any of a variety of commercially available processors. Dual processors and other multiprocessor architectures may also be utilized as the processing unit (1104). The system bus (1108) may be any of several types of bus structures that may additionally be interconnected to a memory bus, a peripheral bus, and a local bus using any of a variety of commercial bus architectures. The system memory (1106) includes read-only memory (ROM) (1110) and random-access memory (RAM) (1112). A basic input/output system (BIOS) is stored in nonvolatile memory (1110), such as ROM, EPROM, EEPROM, and includes basic routines that help transfer information between components within the computer (1102), such as during startup. The RAM (1112) may also include high-speed RAM, such as static RAM, for caching data. The computer (1102) also includes an internal hard disk drive (HDD) (1114) (e.g., EIDE, SATA)—which may also be configured for external use within a suitable chassis (not shown), a magnetic floppy disk drive (FDD) (1116) (e.g., for reading from or writing to a removable diskette (1118)), and an optical disk drive (1120) (e.g., for reading from or writing to a CD-ROM disk (1122) or other high capacity optical media such as a DVD). The hard disk drive (1114), the magnetic disk drive (1116), and the optical disk drive (1120) may be connected to the system bus (1108) by a hard disk drive interface (1124), a magnetic disk drive interface (1126), and an optical drive interface (1128), respectively. An interface (1124) for implementing an external drive comprises at least one or both of Universal Serial Bus (USB) and IEEE 1394 interface technologies. The drives and their associated computer-readable media provide nonvolatile storage of data, data structures, computer-executable instructions, and the like. In the case of a computer (1102), the drives and media correspond to storing any data in a suitable digital format. While the description of computer-readable media above refers to HDDs, removable magnetic disks, and removable optical media such as CDs or DVDs, those skilled in the art will appreciate that other types of media readable by a computer, such as zip drives, magnetic cassettes, flash memory cards, cartridges, and the like, may also be used in the exemplary operating environment, and that any such media may contain computer-executable instructions for performing the methods of the present disclosure. A number of program modules, including an operating system (1130), one or more application programs (1132), other program modules (1134), and program data (1136), may be stored in the drive and RAM (1112). All or portions of the operating system, applications, modules, and/or data may also be cached in RAM (1112). It will be appreciated that the present disclosure may be implemented in a variety of commercially available operating systems or combinations of operating systems.

A user may enter commands and information into the computer (1102) via one or more wired/wireless input devices, such as a keyboard (1138) and a pointing device such as a mouse (1140). Other input devices (not shown) may include a microphone, an IR remote control, a joystick, a game pad, a stylus pen, a touch screen, and the like. These and other input devices are often connected to the processing unit (1104) via an input device interface (1142) that is connected to the system bus (1108), but may also be connected via other interfaces such as a parallel port, an IEEE 1394 serial port, a game port, a USB port, an IR interface, and the like. A monitor (1144) or other type of display device is also connected to the system bus (1108) via an interface such as a video adapter (1146). In addition to the monitor (1144), the computer typically includes other peripheral output devices (not shown), such as speakers, a printer, and the like. The computer (1102) may operate in a networked environment using logical connections to one or more remote computers, such as remote computer(s) (1148), via wired and/or wireless communications. The remote computer(s) (1148) may be a workstation, a computing device computer, a router, a personal computer, a portable computer, a microprocessor-based entertainment device, a peer device, or other conventional network node, and may generally include many or all of the components described for the computer (1102), but for simplicity, only the memory storage device (1150) is illustrated. The logical connections illustrated include wired/wireless connections to a local area network (LAN) (1152) and/or a larger network, such as a wide area network (WAN) (1154). Such LAN and WAN networking environments are common in offices and companies, and facilitate enterprise-wide computer networks, such as intranets, all of which may be connected to a worldwide computer network, such as the Internet. When used in a LAN networking environment, the computer (1102) is connected to the local network (1152) via a wired and/or wireless communications network interface or adapter (1156). The adapter (1156) may facilitate wired or wireless communications to the LAN (1152), which may also include a wireless access point installed therein for communicating with the wireless adapter (1156). When used in a WAN networking environment, the computer (1102) may include a modem (1158), be connected to a communications computing device on the WAN (1154), or have other means for establishing communications over the WAN (1154), such as via the Internet. The modem (1158), which may be internal or external and wired or wireless, is connected to the system bus (1108) via a input device interface (1142). In a networked environment, the program modules described for the computer (1102) or portions thereof may be stored in a remote memory/storage device (1150). It will be appreciated that the network connection depicted is exemplary and that other means of establishing a communications link between the computers may be used.

The computer (1102) is configured to communicate with any wireless device or entity that is configured and operates in wireless communication, such as a printer, scanner, desktop and/or portable computer, portable data assistant (PDA), communication satellite, any equipment or location associated with a radio-detectable tag, and a telephone. This includes at least Wi-Fi and Bluetooth wireless technologies. Accordingly, the communication may be a predefined structure as in a conventional network or may simply be an ad hoc communication between at least two devices.

Wireless Fidelity (Wi-Fi) enables connection to the Internet, etc., without wires. Wi-Fi is a wireless technology, such as a cell phone, that allows such devices, such as computers, to transmit and receive data indoors and outdoors, i.e., anywhere within the coverage area of a base station. Wi-Fi networks use wireless technologies known as IEEE 802.11 (a, b, g, etc.) to provide secure, reliable, and high-speed wireless connections. Wi-Fi can be used to connect computers to each other, to the Internet, and to wired networks (using IEEE 802.3 or Ethernet). Wi-Fi networks can operate in the unlicensed 2.4 and 5 GHz radio bands, at data rates of, for example, 11 Mbps (802.11a) or 54 Mbps (802.11b), or in products that include both bands (dual band). Those skilled in the art will appreciate that information and signals may be represented using any of a variety of different technologies and techniques. For example, the data, instructions, commands, information, signals, bits, symbols, and chips that may be referenced in the above description may be represented by voltages, currents, electromagnetic waves, magnetic fields or particles, optical fields or particles, or any combination thereof. Those skilled in the art will appreciate that the various exemplary logical blocks, modules, processors, means, circuits, and algorithm steps described in connection with the embodiments disclosed herein may be implemented as electronic hardware, various forms of program or design code (referred to herein for convenience as software), or a combination of both. To clearly illustrate this interchangeability of hardware and software, various exemplary components, blocks, modules, circuits, and steps have been described above generally in terms of their functionality. Whether such functionality is implemented as hardware or software depends upon the particular application and design constraints imposed on the overall system. Those skilled in the art of the present disclosure may implement the described functionality in a variety of ways for each particular application, but such implementation decisions should not be construed as causing a departure from the scope of the present disclosure.

The various embodiments presented herein can be implemented as a method, apparatus, or article of manufacture using standard programming and/or engineering techniques. The term article of manufacture includes a computer program, carrier, or media accessible from any computer-readable storage device. For example, computer-readable storage media include, but are not limited to, magnetic storage devices (e.g., hard disks, floppy disks, magnetic strips, etc.), optical disks (e.g., CDs, DVDs, etc.), smart cards, and flash memory devices (e.g., EEPROMs, cards, sticks, key drives, etc.). In addition, the various storage media presented herein include one or more devices and/or other machine-readable media for storing information.

It is to be understood that the specific order or hierarchy of steps in the processes presented are examples of exemplary approaches. Based on design priorities, it is to be understood that the specific order or hierarchy of steps in the processes may be rearranged within the scope of the present disclosure. The appended method claims provide elements of various steps in a sample order, but are not meant to be limited to the specific order or hierarchy presented.

According to one embodiment of the present disclosure, a method for managing a battery using operational status information including takeoff and landing of an aircraft may include the following steps: a step of obtaining a flight plan based on battery status information and movement distance information; a power management step of managing at least one battery monitoring unit mounted on the battery based on the operational status information during a flight according to the flight plan; a battery management step of individually controlling a battery formed of a plurality of battery packs

Here, the aircraft includes an aircraft, and may preferably be an Urban Air Mobility (UAM). UAM may mean an autonomously driving aircraft, and vertical movement may consume more energy than horizontal movement when the aircraft moves. For example, if the propeller rotates at 600 rpm during horizontal movement, the propeller rotates at 1000 rpm during vertical movement to enable vertical movement. To this end, the motor's energy may be consumed more during vertical movement. At this time, the vertical movement may be a movement that ascends in a vertical direction. For example, when moving to lower the altitude in a vertical direction, it can be easily done by changing the direction of the propeller blades, and it may consume a similar amount of energy as the energy required for horizontal movement. In addition, the operation status information may mean the movement status information of the aircraft. Specifically, it may be aircraft movement status information such as during takeoff, during landing, during stop, during horizontal movement, and during vertical movement. This operation status information may utilize a device or system that can determine the location, such as a GCS (Ground Control System), an altitude sensor, or a GPS (Global Positioning System).

In addition, the battery may be a device capable of supplying power to the gas. The power may be electricity, or may utilize hydrogen electric power generation. In the present disclosure, it may mean a battery pack. The battery pack may be a shape in which a number of battery modules or battery cells are assembled, and may operate each module or cell singly or in a composite manner. At this time, it may be individually connected so that power can be drawn as much as needed.

In addition, the battery status information may comprehensively represent the battery status information using the battery's SOC (State Of Charge), SOH (State Of Health), and OCV (Open Circuit Voltage).

Here, the SOC (State Of Charge) may be the remaining capacity or charging status of the battery. In addition, the SOH (State Of Health) may be the battery's life information. In addition, the OCV (Open Circuit Voltage) may mean the circuit open battery voltage, and may be used to check charging and discharging by using the curve graphs of the SOC and OCV to be stable or move to the right or left, and the current charge amount may be checked. The step of obtaining a flight plan may be to check the remaining capacity of the battery using the above method and obtain a flight plan based on the remaining capacity and movement distance information.

At this time, the movement distance information may be the vertical movement distance among various movement routes. Since a major accident may occur if the battery is discharged while the aircraft is flying in the air, the movement distance with the greatest battery consumption may be compared with the status information of the battery, and if flight is possible, a flight plan with the optimal movement distance may be obtained. The optimal movement distance may be the shortest movement distance. Here, the flight plan may be generated by the computing device itself, but is not limited thereto, and may be obtained from an external server or the web, etc.

The power management step may be to compare the required battery consumption and the status information of the power supply when a flight is performed according to the flight plan obtained through the step of obtaining the flight plan, and to check whether the battery pack is operating, whether the battery monitoring unit described below is operating, and whether the movement distance according to the flight plan is possible.

In addition, the battery management step may be to obtain a flight plan by calculating the movement distance using the remaining batteries excluding the corresponding battery pack when a problem occurs in the battery. In addition, the battery monitoring unit may be formed in multiple forms.

According to one embodiment of the present disclosure, the battery may be formed in multiple forms of at least one of a battery pack, a battery module, and a battery cell, and the battery pack may include at least one of a temperature sensor, a gas sensor, a current meter, and a voltage meter, and the battery pack may be controlled by at least one battery monitoring unit.

Here, the battery cell may mean the minimum unit in which the battery is formed, the battery module may be in the form of a plurality of battery cells gathered together, and the battery pack may be in the form of a plurality of battery cells or/and battery modules gathered together.

In the present disclosure, it may mean a battery pack. The battery pack is configured to be individually controlled so that a plurality of batteries can be gathered into one and draw the necessary power, and when a large amount of power is required, it may be possible to control the power consumption by using a plurality of battery packs.

In addition, the aircraft abnormality information may be used to indicate that a problem occurs in the battery or propeller, etc., by using various sensors and measuring devices. For example, when the temperature of the battery rises abnormally, it is possible to identify a problem in the battery. In addition, if overcurrent or overvoltage occurs using a current or voltage meter, it can be known that a problem has occurred in the corresponding battery. In particular, it can be used to check for abnormalities that may occur in individual battery packs.

In addition, each battery pack may be equipped with a temperature sensor, a gas sensor, a current meter, and a voltage meter. These configurations can detect various risks including temperature and gas generation of the battery pack, and a computing device that detects the detected risk can control the connection of the corresponding battery pack. At this time, the control of the battery pack and various sensors can be performed by a battery monitoring unit. A plurality of battery monitoring units may be formed, each of which may be formed in parallel with the battery. For example, three battery monitoring units may be connected to each battery and manage the battery in the same manner. This means that if any one of the battery monitoring units fails, the multiple battery monitoring units can be compared to detect and stop the use of the failed unit among the battery monitoring units, thereby enabling stable battery management.

According to one embodiment of the present disclosure, the battery is connected in parallel with a plurality of the battery monitoring units, and the power management step may deactivate a battery monitoring unit except for one of the plurality of the battery monitoring units among the operating status information at the time of takeoff or landing.

A plurality of battery monitoring units may be connected in parallel with the battery.

Since there is a possibility that the battery monitoring unit may malfunction, the exact status of the battery can be identified by operating multiple units.

For example, if one of the multiple battery monitoring units malfunctions, an indicator indicating the status of the battery may change. Accordingly, comparing the multiple battery monitoring units may indicate a malfunction of a single or multiple battery monitoring units in which an abnormality is found.

Such battery monitoring units may consume a lot of electricity.

Accordingly, some of the battery monitoring units may be deactivated at the time of takeoff or landing.

For example, during takeoff or landing, the motor may perform a task of rapidly increasing the RPM in order to ascend or descend the aircraft. Accordingly, the amount of power consumed becomes very large, and the battery may be overloaded to provide such power. To prevent this, when the aircraft takes off or lands, only one of the plurality of battery monitoring units may be operated, and the remaining battery monitoring units may be deactivated.

According to one embodiment of the present disclosure, the power management step may determine whether the battery monitoring unit is activated/deactivated based on the status information of the battery during vertical movement according to the flight plan.

When the aircraft flies according to the flight plan, horizontal movement and vertical movement coexist.

While low power is used on average during such horizontal movement, a large amount of power may be required during vertical movement. Accordingly, the battery monitoring unit may be deactivated in a way that can minimize power consumption of the battery. This will be described in detail below.

According to one embodiment of the present disclosure, the power management step may obtain first vertical movement ratio information, which is a ratio of vertical movement/horizontal movement according to the flight plan, and when moving according to the flight plan, if second vertical movement ratio information, which is actual vertical movement ratio information, is greater than the ratio according to the first vertical movement ratio information, some of the plurality of battery monitoring units may be deactivated.

Vertical movement and horizontal movement may be calculated according to the flight plan, and vertical movement/horizontal movement may be calculated.

First vertical movement ratio information for the calculated vertical movement/horizontal movement ratio may be obtained.

In addition, second vertical movement ratio information, which is actual vertical movement ratio information during flight, may be obtained.

The obtained first vertical movement ratio information and second vertical movement ratio information may be compared to determine whether to activate or deactivate the battery monitoring unit.

For example, if the second vertical movement ratio information is greater than the first vertical movement ratio information, if there are multiple battery monitoring units currently activated, one battery monitoring unit may be activated and the remaining battery monitoring units may be deactivated.

According to one embodiment of the present disclosure, the power management step may be to deactivate sensors except for the temperature sensor when the ratio of the first vertical movement ratio information and the second vertical movement ratio information differs by a predetermined value or more.

The power management step may be to activate only a single battery monitoring unit and cut off power to all gas sensors, current meters, and voltage meters formed in each battery pack when the second vertical movement ratio information is greater than the first vertical movement ratio information and the ratio differs by a predetermined value or more.

At this time, the temperature sensor may be kept in an activated state at all times.

The temperature sensor may be an important signal indicating a risk of the battery. Accordingly, the temperature sensor may be kept in an activated state at all times so that the risk of the battery can be detected.

According to one embodiment of the present disclosure, the battery management step may be to measure the temperature of the battery pack using the temperature sensor, and when the battery pack with an abnormally increased temperature is identified, the connection of the battery pack with an abnormally increased temperature is blocked, and some of the activated plurality of battery monitoring units may be deactivated. These temperature sensors can be kept always activated, free from battery shortage and deactivation of the battery monitoring unit.

Even if a problem is found in the battery and the probability of fire occurs increases, the temperature sensor that can be checked first is always kept activated.

Individually checking through the temperature sensor mounted on each battery pack, if an abnormal temperature rise is confirmed in at least one battery pack, the connection to the corresponding battery pack (the battery pack in which the abnormal temperature rise is confirmed) can be blocked. At this time, an example of blocking the connection can be blocking the electrical connection between the battery pack and the motor. Specifically, it can be done by blocking the wire or using a fuse, etc.

If the connection of the battery pack is blocked, power cannot be supplied from the corresponding battery pack, but it can be safe from the risk of fire, etc.

For example, when blocking the connection of the battery pack, if there are multiple battery monitoring units currently activated, a single battery monitoring unit can be activated and the remaining battery monitoring units can be deactivated.

According to one embodiment of the present disclosure, in the battery management step, the battery pack measures the temperature using a temperature sensor, and if an abnormal temperature increase is confirmed and the battery monitoring unit is activated, the connection of the battery pack is blocked and some of the activated sensors can be deactivated.

If an abnormal temperature increase occurs for each battery pack, the connection of the corresponding battery pack may be blocked. At this time, if the activation state of the battery monitoring unit is a state in which only a single battery monitoring unit is activated, the connection of the gas sensor, current meter, and voltage meter connected to the battery monitoring unit may be blocked.

If a battery pack is blocked due to an abnormality in the battery pack, the battery power is not supplied, so the insufficient battery may be saved by blocking the connection of the sensor or the battery monitoring unit.

According to another embodiment of the present disclosure, the method may be a method for managing a battery according to a flight plan including takeoff and landing of an aircraft.

Specifically, the method for managing a battery by obtaining a flight plan using operation status information including takeoff and landing of the aircraft may include the following steps. A step for calculating the battery consumption required to move to a destination and obtaining a flight plan based on the battery consumption and the current remaining battery amount of the aircraft; a step for obtaining a modified flight plan based on aircraft movement information including the vertical movement and horizontal movement rates of the aircraft; and a step for determining the modified flight plan as a final flight plan.

Here, the aircraft may be UAM (Urban Air Mobility) as described above. It may mean an aircraft that can fly in the air by turning a propeller using a battery. Additionally, for UAM (Urban Air Mobility), reducing weight may be the best in terms of energy efficiency, and thus may be autonomous driving without a pilot.

In addition, the operating status information of the aircraft may mean the status of the aircraft while stationary, taking off, landing, moving vertically, moving horizontally, etc.

In addition, the battery consumption may be the energy required when the passenger moves to a desired destination, and specifically, may be the consumption amount of the battery that operates the propeller.

In addition, the remaining battery amount may be the amount of remaining power of the battery mounted on the aircraft. For example, the remaining battery capacity can be a comprehensive indication of the battery status information using SOC (State Of Charge), SOH (State Of Health), and OCV (Open Circuit Voltage).

In addition, the aircraft movement information can mean the direction in which the aircraft (UAM: Urban Air Mobility) moves. For example, the aircraft movement information can mean vertical movement and horizontal movement, and the ratio between them.

Specifically, the vertical movement of the aircraft can mean the operation of UAM (Urban Air Mobility) increasing the rotational power of the propeller while increasing the altitude in a direction perpendicular to the ground, and can include the operation of lowering the altitude in the opposite direction. The downward motion may be to rapidly increase the rotational force of the propeller when it approaches within a certain distance from the ground, thereby allowing the aircraft to land safely.

The vertical movement gains power by rapidly increasing the power consumption of the aircraft, but on the other hand, the heat generated from the power device increases exponentially, and heat can be generated together due to the resistance of the battery that supplies the power. In addition, horizontal movement may be moving in a direction parallel to the ground while maintaining the altitude of the aircraft.

When the aircraft moves horizontally, power consumption may be lower than when moving vertically. For example, horizontal movement may be possible by changing the angle of the propeller while maintaining the same number of rotations of the propeller, and thus power consumption and heat generation may be maintained constant.

In addition, the flight plan may be to calculate the travel distance to the destination and the battery consumption consumed during movement, check whether it is possible to travel to the destination with the current remaining battery amount, and obtain or create a flight plan. For example, the computing device may generate a flight plan on its own or may obtain the flight plan from an external server or the web.

For example, if the current distance that can be moved with the remaining battery capacity of the aircraft is 100 km, if the destination is located within 100 km, this may be included in the flight plan.

In addition, the flight plan may be to form a waypoint where the aircraft can charge the battery when traveling a long distance.

By charging the battery using the waypoint, it is possible to travel a long distance. Additionally, the modified flight plan may be based on the movement distance according to the flight plan, and the flight plan may be modified by applying a vertical movement ratio that increases power consumption when the aircraft moves.

For example, if the movement distance according to the flight plan is 100 km and the aircraft's possible movement distance is 110 km, if the vertical movement ratio according to the movement distance is given a high weight of 150%, the power consumption equivalent to the vertical movement ratio is weighted, and if the aircraft's possible movement distance is reduced to 90 km accordingly, the destination may be modified to be unmovable. In this case, the destination (a closer destination) can be modified and the movement to that destination can be created as a modified flight plan.

Lastly, in the step of acquiring the flight plan, the method of acquiring the flight plan may be a flight plan already stored in a computing device built into the aircraft, provided by a data center located on the ground, or generated by the computing device itself.

At this time, the flight plan may be generated based on the power used for vertical and horizontal movement according to the previous flight plan.

According to another embodiment of the present disclosure, the step of obtaining the revised flight plan may apply a predetermined rate to battery consumption according to weather conditions.

The battery consumption may increase or decrease depending on the weather conditions that change rapidly while the aircraft is in flight. Accordingly, the modified flight plan may be obtained by predicting the battery consumption.

Here, the flight plan is a flight plan obtained based on the movement distance of the aircraft according to the movement distance to the destination and the battery consumption, and at this time, the real-time weather conditions may be additionally applied.

For example, when the wind blows in the opposite direction during movement according to the flight plan, the power required for the aircraft to move may increase. Accordingly, the power consumption may be added by a predetermined ratio. Specifically, when the wind blows in the opposite direction at 20 m/s during movement to the destination, the speed of the aircraft propeller must be increased by 30%, and accordingly, the amount of battery consumed may be increased by 30% and calculated. Accordingly, when the wind blows in the opposite direction, the movement distance of the aircraft may decrease. On the contrary, if the wind blows in the forward direction, the distance that the aircraft can move may increase.

According to another embodiment of the present disclosure, the step of obtaining the modified flight plan may calculate the amount of battery to travel to the destination by reflecting the vertical movement/horizontal movement ratio as the maximum value in the aircraft movement information.

Here, the modified flight plan may apply the ratio of horizontal movement and vertical movement required during movement to the destination according to the flight plan. For example, the RPM (Rotations per Minute) of the propeller required for horizontal movement and the RPM (Rotations per Minute) of the propeller required for vertical movement may be different. In particular, the vertical movement may be to exert greater force through more rotations.

Accordingly, the modified flight plan may be to modify the plan so that the aircraft can safely travel to the destination by using the ratio of vertical movement and horizontal movement. For example, if the ratio of vertical movement distance/horizontal movement distance according to the current flight plan is 120%, the maximum movement distance of the aircraft may be calculated by applying the ratio with the highest vertical movement ratio among the flight plans, and a location within the maximum movement distance may be set as the destination to obtain the flight plan.

As described above, if a place within the maximum travel distance is created as the destination, movement according to the revised flight plan may be possible even if the flight plan must inevitably be modified.

According to another embodiment of the present disclosure, the step of obtaining the modified flight plan may include: if the vertical movement/horizontal movement ratio for the movement section up to the present during the flight of the aircraft is higher than a predetermined ratio compared to the vertical movement/horizontal movement ratio according to the flight plan, the amount of battery required to move to the destination may be calculated by reflecting the vertical movement/horizontal movement ratio as the maximum value during the flight from the current location to the destination.

Here, the modified flight plan may be a flight plan that is modified in real time during the movement of the aircraft.

Specifically, the modified flight plan may be obtained according to the vertical movement/horizontal movement ratio. For example, when the aircraft moves, if the vertical movement/horizontal movement ratio is higher than the predetermined ratio (130%) according to the flight plan during the movement from the departure point to the current position, the maximum vertical movement/horizontal movement ratio of 150% may be applied to calculate the amount of battery consumed when moving from the current position to the destination.

At this time, if movement to the destination is impossible, the maximum vertical movement/horizontal movement ratio may be applied to set a landing location located within the distance that can be moved as the destination.

According to another embodiment of the present disclosure, the step of generating the modified flight plan may obtain base information including information on a charging location and a landing location included in an area that can be moved with the battery amount of the aircraft, and determine a location among the base information that is close to the destination by a preset value as a temporary candidate destination.

The flight plan described above may be a plan for moving to multiple locations, and the modified flight plan may also be a plan for multiple locations.

For example, it may be a plan for places located within a distance that the aircraft can travel to.

In addition, it may have at least one destination, and a place meeting the conditions may be selected from among each destination.

The step of obtaining the modified flight plan may include all places within the area that can be moved with the battery capacity of the aircraft.

For example, it may include a charging place where the aircraft can be charged and a landing place that can be used as a destination.

These charging places and landing places may be based on places close to the destination desired by the passenger.

For example, a preset value (a certain number) of locations may be determined as temporary candidate destinations in the order of closest proximity to the passenger's desired destination.

The temporary candidate destination may be a place where the aircraft can land when moving to the destination desired by the passenger.

For example, it may be a building rooftop, a playground, a park, a charging station (a place installed for charging UAM), etc. that is closest to the destination desired by the passenger and where the aircraft can land.

According to one embodiment of the present disclosure, the step of generating the modified flight plan may transmit inquiry data for checking whether landing is possible for the temporary candidate destination, and determine the candidate destination based on response data to the inquiry data transmitted from the temporary candidate destination. Here, the candidate destination may be a place where landing is possible among the temporary candidate destinations.

For example, if there is a place where landing is possible on the roof of a hospital, but landing is impossible due to an emergency patient, the place may be excluded from the candidate destinations.

At this time, as a method for setting the candidate destination, the computing device may transmit inquiry data regarding whether landing is possible at each landing site. In addition, the transmitted inquiry data may be checked at the landing site, and response data regarding whether landing is possible or not may be received to determine a place where landing is possible as a candidate destination.

For example, if the inquiry data is transmitted to a control center or server installed at the landing site, and response data is transmitted from the control center or server and it is notified that landing is possible, the candidate destination may be determined as possible for landing.

According to another embodiment of the present disclosure, the step of determining the modified flight plan may provide the candidate destination information to the passenger, determine a place according to the destination selection information selected by the passenger from the provided candidate destination information as a landing destination, and determine the landing destination as the destination of the modified flight plan. Here, the landing destination may be a landing location selected by the passenger from among candidate destinations that are close to the destination desired by the passenger.

For example, if the passenger wants a department store close to the destination as the landing location, the department store may be determined as the landing destination.

To this end, the computing device may transmit information about the candidate destination to the passenger, and determine the landing location as the landing destination based on response data about the location selected by the passenger from among the transmitted candidate destinations.

The location determined as the landing destination may be set as the destination in the revised flight plan.

The revised flight plan may obtain a flight plan based on the determined destination when the destination is determined.

According to another embodiment of the present disclosure, in the step of generating the modified flight plan, when the priority transit point selected by the passenger among the charging point and the landing point is a charging point, when determining the temporary candidate destination, the charging point is first selected, but if the charging point is lower than the preset value, the landing point can be additionally selected.

Here, the charging point can be a place where the aircraft (UAM: Urban Air Mobility) can be charged.

In addition, the landing point can be a place where the aircraft can land, but cannot be charged.

Passengers can use the aircraft one-way or round-trip. In the case of one-way use, they can go to the destination and do their business. However, in the case of round-trip use, since the battery was consumed when moving from the departure point to the destination, the battery amount upon return may be less than the required battery amount. At this time, the landing point can be set as the destination so that charging can be done along with landing, and charging can be done while doing their business. Specifically, when a passenger inputs a desired destination and selects a charging location as an option, when determining a temporary candidate destination, the charging location may be determined as a temporary candidate destination in the order of proximity to the destination.

At this time, the temporary candidate destination may be selected by a preset value (a specific number), and if the number of charging locations close to the destination is less than the preset value, additional locations may be selected.

For example, if the preset value is 10, a charging location close to the passenger's desired destination may be selected, and if the number of selected charging locations is 7, 3 landing locations may be added to set 10 locations as temporary candidate destinations. At this time, it may be clearly indicated that they are charging and landing locations.

According to another embodiment of the present disclosure, in the step of generating the modified flight plan, when the priority transit location selected by the passenger among the charging location and the landing location is a landing location, when determining the temporary candidate destination, the landing location is first selected, but if the landing location is less than the preset value, the charging location may be additionally selected. Here, the landing location may be a location where the passenger can land close to the desired destination.

If the passenger selects the landing location as a priority transit location, the landing location close to the passenger's desired destination may be determined as a temporary candidate destination.

This is an option that can be selected when the passenger's desired destination is closer to the landing location than the charging location or when the passenger must move in a hurry.

If the landing location is selected as a priority transit location, the passenger may first select a landing location close to the desired destination, and at this time, the selected location may be a preset value (a specific number).

For example, if the preset value is 10, 10 landing locations close to the passenger's desired destination (within a certain distance) are selected, but if 10 locations are not selected but are outside a certain distance, a charging location within a certain distance may be additionally selected.

The 10 locations selected as above may be determined as temporary candidate destinations. This battery management method can enable safe flight by measuring the battery of the aircraft (UAM: Urban Air Mobility), obtaining an optimal flight plan based on the available battery amount, and modifying the flight plan by assuming the worst case scenario in the obtained flight plan. In addition, it can provide an optimal travel path for a passenger boarding the aircraft to move to a desired destination.

The description of the presented embodiments is provided so that any person skilled in the art in the art of the present disclosure can use or practice the present disclosure. Various modifications to these embodiments will be apparent to those skilled in the art in the art of the present disclosure, and the general principles defined herein can be applied to other embodiments without departing from the scope of the present disclosure. Thus, the present disclosure is not limited to the embodiments presented herein, but should be interpreted in the broadest scope consistent with the principles and novel features presented herein.

What is claimed is:

1. A method for managing a battery according to a flight plan using operational status information including takeoff and landing of an aircraft, comprising:
a step of calculating a battery consumption consumed during movement to a destination according to the flight plan, and obtaining the flight plan based on the battery consumption and current remaining battery capacity of the aircraft;
a step of generating a modified flight plan by modifying the flight plan based on aircraft movement information including vertical movement and horizontal movement rates of the aircraft; and
a step of determining the modified flight plan as a final flight plan.

2. The method of claim 1, wherein:
the step of generating the modified flight plan comprises:
applying a predetermined rate to the battery consumption according to weather conditions, and
the flight plan includes takeoff and landing of an aircraft.

3. The method of claim 1, wherein
the step of generating the modified flight plan comprises:
if the vertical movement/horizontal movement ratio for a movement section up to current time during the flight of the aircraft is higher than a predetermined ratio compared to the vertical movement/horizontal movement ratio according to the flight plan, an amount of battery required to move to the destination is calculated by reflecting the vertical movement/horizontal movement ratio as the maximum value during the flight from a current location to the destination, and
the flight plan includes takeoff and landing of an aircraft.

4. The method of claim 1, wherein
the step of generating the modified flight plan comprises:
acquiring base information including information on charging locations and landing locations included in an area movable with the battery capacity of the aircraft, and determining a location among the base information that is close to the destination by a preset value as a temporary candidate destination, and
the flight plan includes takeoff and landing of an aircraft.

5. The method of claim 4, wherein
the step of generating the modified flight plan comprises:
sending inquiry data for checking whether landing is possible for the temporary candidate destination, and
determining the candidate destination based on response data to the inquiry data transmitted from the temporary candidate destination, and
the flight plan includes takeoff and landing of an aircraft.

6. The method of claim 5, wherein
the step of determining the modified flight plan comprises:
providing information on the candidate destination to a passenger, determining a location according to destination selection information selected by the passenger from among the provided candidate destination information as a landing destination, and
determining the landing destination as a destination of the modified flight plan, and
the flight plan includes takeoff and landing of an aircraft.

7. The method of claim 4, wherein
the step of generating the modified flight plan comprises:
if priority stopover location selected by a passenger from among the charging location and the landing location is a charging location,
selecting the charging location first as the temporary candidate destination, and if the charging location is below a preset value, additionally selecting a landing location as the temporary candidate destination, and
the flight plan includes takeoff and landing by an aircraft.

8. The method of claim 4, wherein
the step of generating the modified flight plan comprises:
if priority stopover location selected by a passenger from among the charging location and the landing location is a landing location,
selecting the landing location first as the temporary candidate destination, and if the landing location is below a preset value, additionally selecting the charging location as the temporary candidate destination, and
the flight plan includes takeoff and landing by an aircraft.
